(19) United States
(12) Patent Application Publication
(10) Pub. No.: US 2006/0153980 A1
(43) Pub. Date: Jul. 13, 2006

(54) Method for coating objects, electrode arrangement, and coating system

(75) Inventor: Peter Taiana, Staffelbach (CH)

Correspondence Address: MCCORMICK, PAULDING & HUBER LLP, CITY PLACE II, 185 ASYLUM STREET, HARTFORD, CT, 06103, US

(73) Assignee: Elpatronic AG, Bergdietikon (CH)

(21) Appl. No.: 10/563,724

(22) PCT Filed: Jun. 29, 2004
(86) PCT No.: PCT/CH04/00407

§ 371 Date: Jan. 6, 2006

(30) Foreign Application Priority Data
Jul. 7, 2003 (CH) 1190/03

(51) Int. Cl. B05D 1/12; B05B 5/025

(52) U.S. Cl. 427/180; 118/625; 118/620

(57) ABSTRACT

For the electrostatic coating of objects, e.g. cans, the coating material is charged by means of an electrode (9). According to the invention, the electrode is vibrated in order to prevent, as far as possible, the coating material from being deposited thereon. To this end, the electrode is embodied as a tongue that is excited by an air current (17) in such a way that it vibrates.

The invention concerns a method for the electrostatic support of the coating of objects with a coating material. It further concerns an electrode arrangement for the creation of an electric field in electrostatically supported coating apparatuses and an electrostatic coating apparatus.

The electrostatic influencing of coating materials in the coating of objects is well known and promotes a very good depositing of the coating particles onto the object. Applications for this type of coating are found in many areas, especially in the coating of the welding seam on the inner side of cans sides with a powder form of coating material, as is for example known from DE-A-42 27 455. It is further known to protect the field creating electrode from direct impact by the powder/air mixture by a ring and also to additionally clean the electrode by an air stream to keep fouling of the electrode by the powder particles to a minimum. Depending on the type of powder used there can however accrue a more or less heavy accumulation of powder on the electrode, which is especially a problem with a polyamide coating powder, and can lead to a sintering effect at the electrode. A fouled electrode changes the operating conditions of the coating process and leads possibly to an operational breakdown of the coating system. The invention has as its object the provision of an improved electrostatic support of the coating process.

This object is solved by the characterizing features of claim 1.

It has been shown that an electrode set into vibration becomes significantly less fouled. The adherence of particles is strongly diminished or practically entirely prevented. With the vibrating electrode the coating quality is not negatively influenced and as a rule it is also not necessary to change the operating parameters of the coating process. The vibration accrues essentially perpendicularly to the electric field lines and/or in the direction of the field lines of the field created by the electrode.

Preferably moving objects are coated in this way, since as a rule the objects are moved suddenly at high speed to and past the coating station so that a reduced coating as a result of electrode fouling can no longer be corrected. This is especially the case in the coating of the welding seam area on the interior of can sides, which is the preferred use of the method. Preferably a vibratable construction of the electrode is used so that the electrode can be brought into vibration by an exciting means. The exciting means for example can operate electromagnetically or piezoelectrically. A preferred construction of the electrode is one which allows the electrode to be set into vibration by an air stream, similarly to the blown reed of a musical wind instrument. As mentioned, it is known to provide a cleaning air stream for the electrode and it is preferred to straightforwardly use cleaning air as the drive for the vibration creation.

Alternatively or additionally to the vibration of the electrode it is possible, in the case of a stationary electrode arrangement and objects moved passed it, to make the electrode drivingly moveable, as for example as a rotated electrode. With such a movement of the electrode, in an electrode arrangement which is basically stationary, during the coating electrode fouling by the coating material can be reduced or avoided. The electrode movement, for example rotation, can be effected electromotively, or also pneumatically, or for example again by the mentioned cleaning air.

As to the object of the invention, the invention further lies in the provision of an improved electrode arrangement and in the making of an improved coating apparatus.

This object is solved in accordance with claims 10 and 17.

In this way the advantages explained in connection with methods are achieved.

The preferred embodiments providing the advantages explained by way of methods concern also the preferred embodiments of the electrode arrangement and of the coating apparatus. Especially the vibrational excitation by an air stream allows an especially simple construction for coating systems, and especially for can coating systems already equipped for the use of an air stream (cleaning air stream). This allows a simple refitting of electrode arrangements in already existing coating apparatuses. Alternatively in the case of a stationary electrode arrangement, or of a coating apparatus with a stationary electrode arrangement, a moved electrode, for example a rotationally moved electrode, can be provided; this possibly in combination with a vibration of an electrode.

In the following exemplary embodiments of the invention are explained in more detail with the help of the drawings. The drawings are:

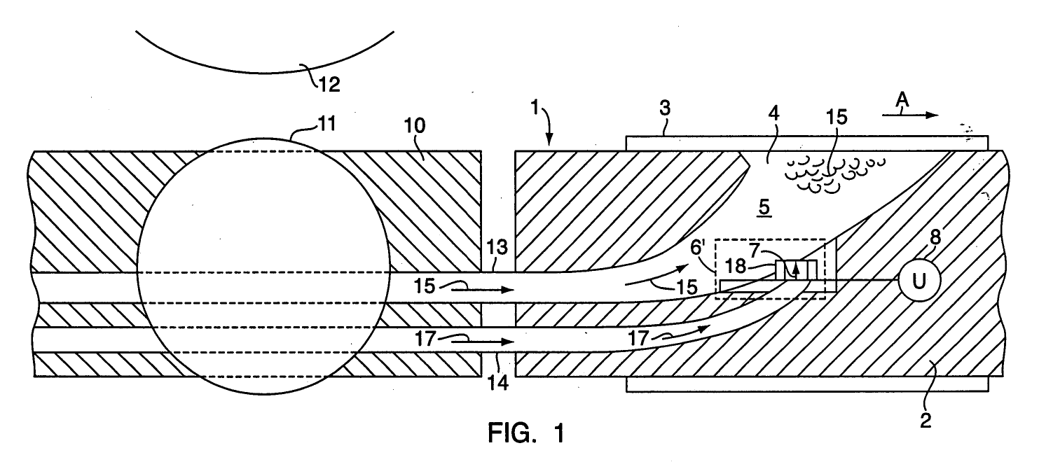

FIG. 1 A schematic sectional view illustrating the coating of a can side;

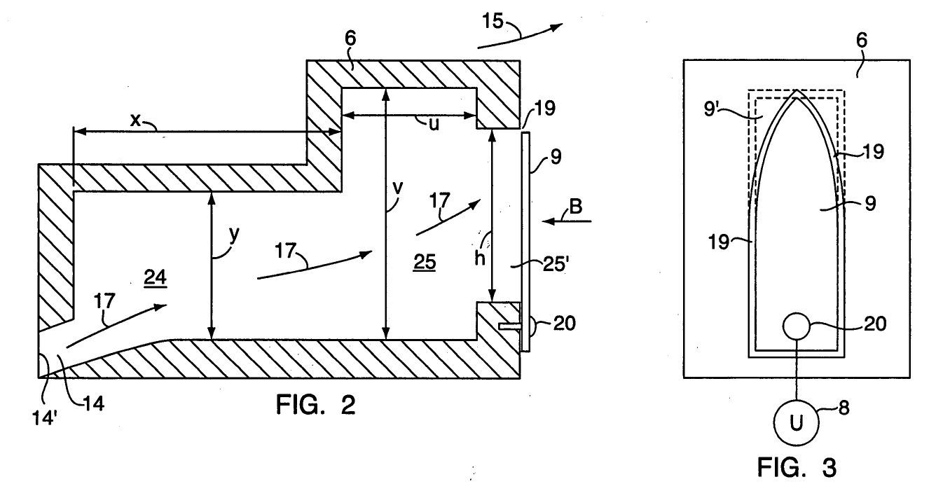

FIG. 2 A sectional view illustrating an electrode arrangement according to the invention;

FIG. 3 A plan view of the electrode arrangement of FIG. 2;

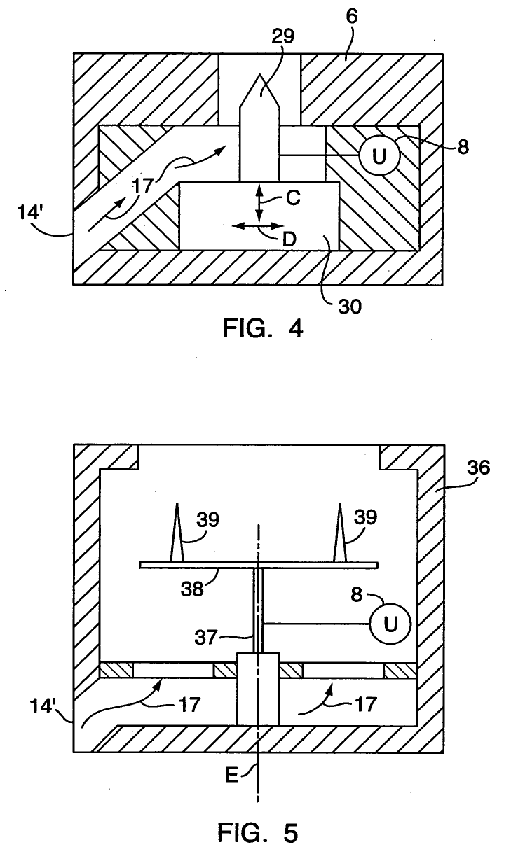

FIG. 4 A schematic view of a further embodiment of the invention; and

FIG. 5 Still another embodiment of the invention.

FIG. 1 shows schematically conditions in the coating of can welding seams on the inner side of can sides as an example of objects to be coated. The invention explained in the following is however also useful in the electrostatic support of the coating of other objects, although the coating of can welding seams is the preferred use. In this, as a rule a powder form of coating material is employed, for example a polyamide powder. Such types of coating materials are known and are not explained in more detail here. In the coating of objects it is further known to employ fluid coating material in drop form, in connection in which the present invention can likewise find use. Such materials are also known and are not explained in more detail here. In FIG. 1 a can side 3 is shown which is positioned on the arm 2 of a coating apparatus 1. The can side in this case is transported by a non-illustrated transport mechanism at high speed in the direction of the arrow A. Previously the can side 3 has been welded in a likewise known way between the welding rolls 11 and 12 of a not further illustrated can welding machine, with in general an intermediate wire welding electrode being used on the welding rolls 11 and 12. The lower welding roll 11 is rotatably supported on the lower arm 10 of the welding machine. At least one conductor 13 for the delivery of a coating powder/air mixture is provided and extends through the lower arm 10 and then into the arm 2 of the coating apparatus. The coating powder in a known way is delivered along the conductor 13 through the welding machine and to the coating apparatus 1 by delivery air. In the figure this powder/air mixture in the conductor 13 is illustrated by the arrows 15, and at the outlet location 4 of the coating apparatus is illustrated as a cloud 15. The coating powder upon its reaching the outlet location 4 gets admitted to the inner side of the can side 3 at its uncoated welding seam and there forms a coating, which subsequently in known ways is burned in and cooled to form a tight coating over the welding seam, which in the region of the welding seam completes the interior coating of the can side. This is known and need not be explained in more detail here. It is also known, as illustrated in FIG. 1, to provide a pointed electrode 7 which is supplied with a high voltage by a voltage source 8. The corresponding electrostatic field formed by this leads in known ways to an influencing of the coating material and to a better adherence of it to the can side 3. In connection with this it is known to protect the pointed electrode by a protective ring 18 and to further allow powder free air delivered by a conductor 14 to move as cleaning air around the electrode and into the space 5, in order to also likewise protect the electrode from the coating material. It has been shown, however, that despite this powder accumulation on the known electrode 7 occurs, especially with the use of a polyamide powder as the coating material. It has already been attempted to attack the powder fouling of the electrode 7 on one hand by an increase in the airspeed of the cooling air, but this has not accomplished the desired result. The speed of the cooling air is upwardly limited since the escaping cooling air dare not seriously disturb the cloud 15. Increasing the high voltage of the electrode 7 has also been tried in order to thereby achieve an increased repelling of the powder from the electrode. It has been shown however that the usual voltage in the range of about 20 kV, and a highest voltage of 25 kV, should not be exceeded. With the higher voltage these results the effect that the lacquer coating lying next to the uncoated welding seam region on the inside of the can side becomes likewise charged, which in turn leads to a repulsion of the coating powder. It is therefore desired, in the case of such an arrangement to use the customary parameter of deaning air speed, corresponding to a cooling airflow quantity of about 1 to 2 liters/minute, and a high voltage in the region of about 20 kV as much as possible. Naturally for other coating situations, such as in the coating of different objects and the use of other coating materials, other standard values apply, yet in these cases for a good coating one should strive to maintain the usual standard values as much as possible.

FIGS. 2 and 3 now show one embodiment of an electrode arrangement 6 according to the invention and for explaining the method according to the invention. This electrode arrangement 6 is directly useable in place of the illustrated electrode arrangement 6′ of FIG. 1. Similar reference numbers indicate thereby the same elements, and especially again the cleaning air conductor is indicated at 14 and the cleaning air by the arrow 17. The arrow 15 above the electrode arrangement 6′ shows a path of the air/powder mixture 15 corresponding to FIG. 1. The electrode arrangement 6′ is as a rule so arranged in the apparatus 1 of FIG. 1, that is has a constant spaced position of the electrode 9 from the object surface to be coated and which position corresponds to that of the electrode 7 according to the state of the art. Other installations are possible, if thereby the desired electrostatic field is created by the electrode 9. This electrode is again connected to a high voltage source 8, which preferably likewise produces a continuous voltage in the region of 20 kV.

According to the invention, the electrode 9 is implemented as a vibrating or oscillating electrode. In the embodiment according to FIGS. 2 and 3 the electrode is made as a leaf spring having one end fastened and its other end lying free; and which spring is preferably arranged in front of the opening 25′ of a resonance space 25. FIG. 2 shows a vertical section through the electrode arrangement 6 with the electrode 9, and FIG. 3 shows a front view in the direction of the arrow B of FIG. 2. It is seen that the vibratable electrode 9 is arranged by a fastening means 20 in front of the opening 25′ of the resonance space 25 and in its outer shape corresponds essentially to this opening so that only a small gap at 19 is formed between the opening 25′ and the electrode 9. The width this gap is, for example, only 1/10 mm. Smaller gap sizes as a rule are to be avoided for a customary coating powder for cans, since otherwise powder particles can become fixedly lodged in the gap 19. A somewhat larger width of the gap 19 can be chosen, but this must be so sized that it produces a vibration of the tongue shaped electrode as a result of the cleaning air delivery 17. The cleaning air namely flows outwardly through the gap and thereby excites the electrode 9 to the desired vibration or oscillation according to the invention. In this preferred embodiment the vibration of the electrode is therefore created by an air stream which preferably consists of the deaning air stream 17. Naturally in the case of other coating situations, in which no deaning air stream is provided, other possibilities for the vibrational excitation of the electrode are used, such as for example a piezoelectric or electromagnetic vibration driver. Also in the case of such situations a special air stream can be created which then serves as the vibration driver. Naturally, vibration by means of an air stream can also be created in other known ways, for example in that an air stream ejected from a jet flows over the upper edge of the electrode and vibrationally deflects it.

As a guide point for a vibration which keeps the electrode 9 effectively free of powder fouling, a vibrational frequency of about 500 Hz at an amplitude at the free end of the electrode of about 0.5 mm can be given. Naturally the vibrational frequency and the amplitude can be freely chosen from quite wider ranges. The mentioned vibrational frequency is adapted to the customary air mass flow of 1 to 2 liters per minute if for the electrode arrangement 6 of FIG. 2 the following measurements are nearly chosen. As the length x of the delivery space 24 for the delivery of the air stream 17 into the resonance space 25 about 60 mm. As the height y of the space 24 about 6 mm. It has been shown that the vibrational excitation and the maintenance of the vibration is better achieved if the resonance space 25 has such a space 24 in front of it, instead of the direct introduction of the conductor 14 into the resonance space 25. The resonance space 25 itself has a height v of about 10 mm and a width u of about 5 mm as has been found suitable if the height h of the free portion of the electrode 9 is about 6 to 7 mm and the width b of the electrode is about 2 mm, with its thickness being about 0.05 mm. The electrode in this case is made of a spring steel and preferably has the tongue like shape shown in FIG. 3. It is however also possible to provide for example a rectangularly shaped electrode 9′, as is shown in FIG. 3 by the broken lines. The housing of the electrode arrangement 6 is made preferably of a plastic material. The voltage source 8, which is connected to the electrode 9, is the same voltage source as is used with the customary pointed electrode. In the case of other coating situations naturally an electrode can be used having another shape and other dimensions. Also the dimensions of the electrode arrangement 6 are naturally variable over a wide range and a resonance space is generally only then necessary if the vibrational excitation is achieved by an air stream. If another possibility for the vibrational excitation is used, for example a piezoelectric or a electromagnetic vibrational excitation, by means of which the vibratable electrode is directly driven in vibration, the air supply and the spaces 24 and 25 are not at all the necessary. Also a vibrational excitation by means of a striking element which only occasionally sets the electrode 9 into vibration by a blow onto the electrode or onto a neighboring housing part or holding part, can also be used to avoid the adherence of coating material and can be sufficient. The excitation into vibration of the electrode can in this case occur periodically or in randomly chosen time spacings.

FIG. 4 shows schematically a further embodiment in which an electrode of customary form is provided inside of the electrode arrangement 6. This pointed electrode 29, which is again connected with the voltage source 8, is fastened to a base 30 which itself forms the actual vibrating element. The electrode 29 in this case is rigid and follows only the movement of the vibrating base. This base can be driven piezoelectrically, electromagnetically or electromotively or in some other known way to produce the vibrations. These vibrations can occur in the direction of the arrows C and/or of the arrows D. In this way a pointed electrode which is cylindrical and rigid in its lower region can be vibrated, for example in the range from 100 Hz up to perhaps 500 Hz or higher. Therefore in this way also the accumulation of coating material can be avoided by the vibration of the electrode. Additionally deaning air 17 can be used in the known way so as to serve for deaning but not for producing vibrational excitation.

According to a further aspect of the invention, which is seen in FIG. 5, the electrode is not vibrated but is moved in another way, preferably by being rotated about an axis E. In the illustrated example of FIG. 5, in the electrode arrangement 6 are two electrodes 39 arranged on a carrier 38, which together with the shaft 37 are rotated about the mentioned rotational axis E. The electrodes are again connected with the voltage source 8. The rotation can for example be produced electromotively or again an air steam, for example the cleaning air stream 17, can be used to drive the electrodes 39, which rotation can be possibly achieved by building the carrier 38 as a corresponding wind impeller. The electrode arrangement 6 is in this case again stationary with respect to the moving objects 3, and only the individual electrode or the individual electrodes 39 are moved.

1. A method for the electrostatic support of the coating of objects with a coating material, wherein at least one field producing electrode during the coating process is set into vibration at least at times and preferably constantly.

2. A method according to claim 1, wherein the objects are moved past the stationary vibrating electrode and in particular are can sides the inner seam regions of which are coated, especially with a powder form of coating material.

3. A method according to claim 1, wherein the electrode is constructed as a vibratable element and is excited into vibration by an exciting means.

4. A method according to claim 3, wherein the electrode is excited into vibration by an air stream, especially a cleaning air stream.

5. A method according to claim 4, wherein the electrode is leaf shaped and especially tongue shaped and is arranged at the opening of a resonance space, and in that the air is guided through a gap between the electrode and the opening.

6. A method according to claim 1, wherein the electrode is made as a rigid element which is oscillated by a drive means.

7. A method according to claim 6, wherein the electrode is immersed in a stream of cleaning air.

8. A method for the electrostatic support of the coating of moving objects with a coating material, with an electrode arrangement arranged stationary and spaced from the objects and including at least one electrode, wherein the electrode during the coating is movably driven at times, especially by being driven in rotational movement about a rotational axis (E).

9. A method according to claim 8, wherein the electrode is moved by an air stream or electromotively.

10. An electrode arrangement for the creation of an electric field in an electrostatically supported coating apparatus, wherein the arrangement has at least one vibrationally moveable electrode.

11. An electrode arrangement according to claim 10, wherein the electrode is formed as a flexible electrode capable of being excited into vibration, especially an electrode excitable into vibration by an air stream.

12. An electrode arrangement according to claim 11, wherein the electrode is essentially of leaf shape, especially of tongue shape, and is fixed at one end.

13. An electrode arrangement according to claim 10, wherein the electrode is fastened at the opening of a space of the arrangement so as to form an air gap, which space is connected to an air inlet of the arrangement.

14. An electrode arrangement according to claim 10, wherein the electrode is formed as an essentially rigid electrode, especially as a pointed electrode, which is fastened on or to a vibrator element.

15. An electrode arrangement for creating an electric field in the electrostatic support of a coating apparatus, wherein the arrangement includes at least one associated electrode driveably rotatable about a rotation axis.

16. An electrode arrangement according to claim 15, wherein it includes an electromotive drive means or an air stream driven rotatable drive means for the rotational movement.

17. A coating apparatus for the coating of objects, especially moving objects, with an electrode arrangement according to claim 10.
